(19) United States
(12) Patent Application Publication
(10) Pub. No.: US 2007/0153342 A1
(43) Pub. Date: Jul. 5, 2007

(54) Display and editing of documents described by schemas

(76) Inventors: Anne R. Sand, Peyton, CO (US); Leah Rae Smutzer, Rochester, MN (US); Richard Joseph Stevens, Rochester, MN (US); Jingdong Sun, Rochester, MN (US); Paul William Wertzler, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/326,571

(22) Filed: Jan. 5, 2006

(51) Int. Cl. H04N 1/46

(52) U.S. Cl. 358/537

(57) ABSTRACT

A method, apparatus, system, and signal-bearing medium that, in an embodiment, create configuration data for a document and display the document via the configuration data. In an embodiment, the configuration data includes display properties, such as icons and description text, associated with elements in the document. In various embodiments, the configuration data may also include graphical element editors, queries, bookmarks, and validation rules. The elements in the document are displayed by interpreting the associated elements in the configuration data. In an embodiment, elements are read from a schema, which is associated with the document. In response to selection of an element, the selected element is defined as a path in configuration data, a selected display property for the selected element is set in the configuration data, and a selected element editor for the selected element is set in the configuration data. In an embodiment, a query is executed to a portion of a different document having a different associated schema, wherein the path specifies the portion.

### FIELD

An embodiment of the invention generally relates to computer systems. In particular, an embodiment of the invention generally relates to editing of documents that are described by schemas.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

One use of these more powerful computer systems is for products that take advantage of XML (Extensible Markup Language) to store configuration data that a user may need to edit or update. Unfortunately, XML data documents tend to be difficult to edit, especially for novice users because of the following limitations of current general-purpose XML editors. First, current XML editors do not hide the syntax of the XML data from the user and instead merely display the entire document in text form, complete with all the cryptic syntax of the control tags, which is confusing for users. Second, some editors offer a tree view of the document that shows the hierarchy of elements (as nodes) within the document, but the nodes can only be distinguishable from one another by studying the attributes of the nodes. Third, when an element in the tree view is expanded, the user sees a list of all the elements that the expanded element contains, but each element is labeled only with its type. To find a specific element, each node must be selected to further view its attributes. Finally, elements and attributes are often displayed with no hints as to what data they contain other than their names, which are often short and unilluminating. Thus, currently general-purpose XML editors have shortcomings that decrease their usability.

Some products attempt to address the shortcomings of general-purpose editors by developing special-purpose editors directed to a particular type of configuration data with a particular schema. A special-purpose editor may have multiple screens, each uniquely built to edit specific elements within a specific schema. Unfortunately, for products that have complex schemas (e.g., where configuration data must be saved across multiple XML files), a general-purpose editor is difficult to develop. Further, many product do not have the resources to build and support a separate and unique editor just to edit one particular type of configuration data.

Thus, a better technique is needed for editing documents encoded using a markup language and in documents described by any type of schema definition language. While the aforementioned problems have been described in the context of configuration data and XML documents, they may occur in the context of any type of data and in documents written in any markup language.

### SUMMARY

A method, apparatus, system, and signal-bearing medium are provided that, in an embodiment, create configuration data for a document and display the document via the configuration data. In an embodiment, the configuration data includes display properties, such as icons and description text, associated with elements in the document. In various embodiments, the configuration data may also include graphical element editors, queries, bookmarks, and validation rules. The elements in the document are displayed by interpreting the associated elements in the configuration data. In an embodiment, elements are read from a schema, which is associated with the document. In response to selection of an element, the selected element is defined as a path in configuration data, a selected display property for the selected element is set in the configuration data, and a selected element editor for the selected element is set in the configuration data. In an embodiment, a query is executed to a portion of a different document having a different associated schema, wherein the path specifies the portion.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2A depicts a block diagram of an example customer data document, according to an embodiment of the invention.

FIG. 2B depicts a block diagram of an example product data document, according to an embodiment of the invention.

FIG. 2C depicts a block diagram of an example services data document, according to an embodiment of the invention.

FIG. 2D depicts a block diagram of an example order data document, according to an embodiment of the invention.

FIG. 3 depicts a block diagram of an example user interface, according to an embodiment of the invention.

FIG. 4 depicts a block diagram of an example user interface, according to an embodiment of the invention.

FIG. 5A depicts a block diagram of example configuration data, according to an embodiment of the invention.

FIG. 5B depicts a block diagram of example configuration data, according to an embodiment of the invention.

FIG. 5C depicts a block diagram of example configuration data, according to an embodiment of the invention.

FIG. 6 depicts a block diagram of a user interface for creating configuration data, according to an embodiment of the invention.

FIG. 7 depicts a block diagram of a user interface for editing multiple elements, according to an embodiment of the invention.

FIG. 8 depicts a flowchart of example processing for creating configuration data, according to an embodiment of the invention.

FIG. 9 depicts a flowchart of example processing for displaying elements, according to an embodiment of the invention.

FIG. 10 depicts a flowchart of further example processing for displaying elements, according to an embodiment of the invention.

FIG. 11 depicts a flowchart of example processing for editing multiple elements, according to an embodiment of the invention.

FIG. 12 depicts a flowchart of example processing for creating element bookmarks, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, an editor creates configuration data for a document and displays the document via the configuration data. The schema describes the elements used by the document and is expressed in terms of definitions of, and constraints on, the elements of the document. In an embodiment, the configuration data includes display properties, such as icons and description text, associated with elements in the document. The configuration data may also include graphical element editors, e.g., pick lists or widgets, as well as queries, bookmarks, and validation rules. The editor displays the elements in the document by interpreting the associated elements in the configuration data. In response to selection of an element, the editor defines the selected element as a path in configuration data, sets a selected display property for the selected element in the configuration data, and sets a selected element editor for the selected element in the configuration data. The editor executes a query to a portion of a different document having a different associated schema, wherein the path specifies the portion of the different document.

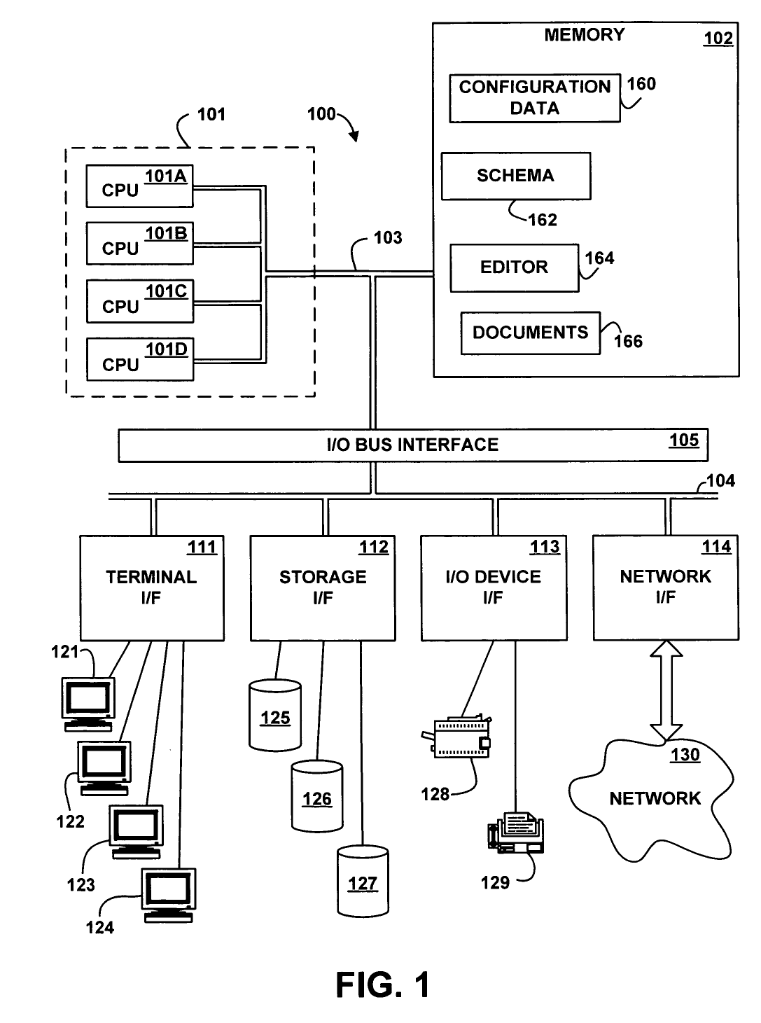

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101 A, 101 B, 101 C, and I01 D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes configuration data 160, a schema 162, an editor 164, and documents 166. Although the configuration data 160, the schema 162, the editor 164, and the documents 166 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the configuration data 160, the schema 162, the editor 164, and the documents 166 are illustrated as being contained within the main memory 102, these elements are not necessarily all completely contained in the same storage device at the same time.

The configuration data 160 describes techniques for visually displaying elements and attributes from the schema 162 that are referenced in the documents 166. The configuration data 160 further describes the linking of elements and attributes from different schemas 162. The schema 162 describes the elements used by the documents 166 and is expressed in terms of definitions of, and constraints on, the elements of the documents 166.

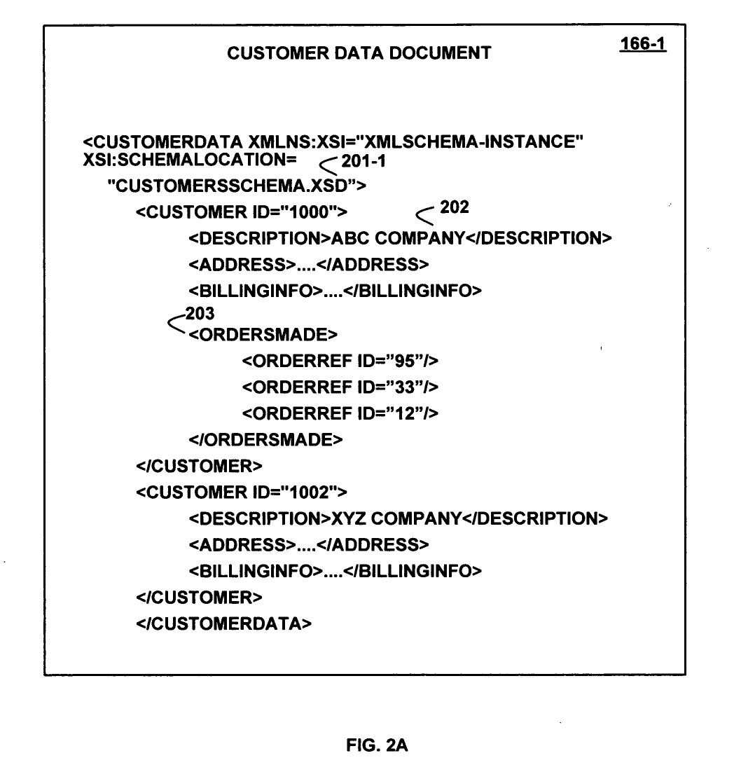

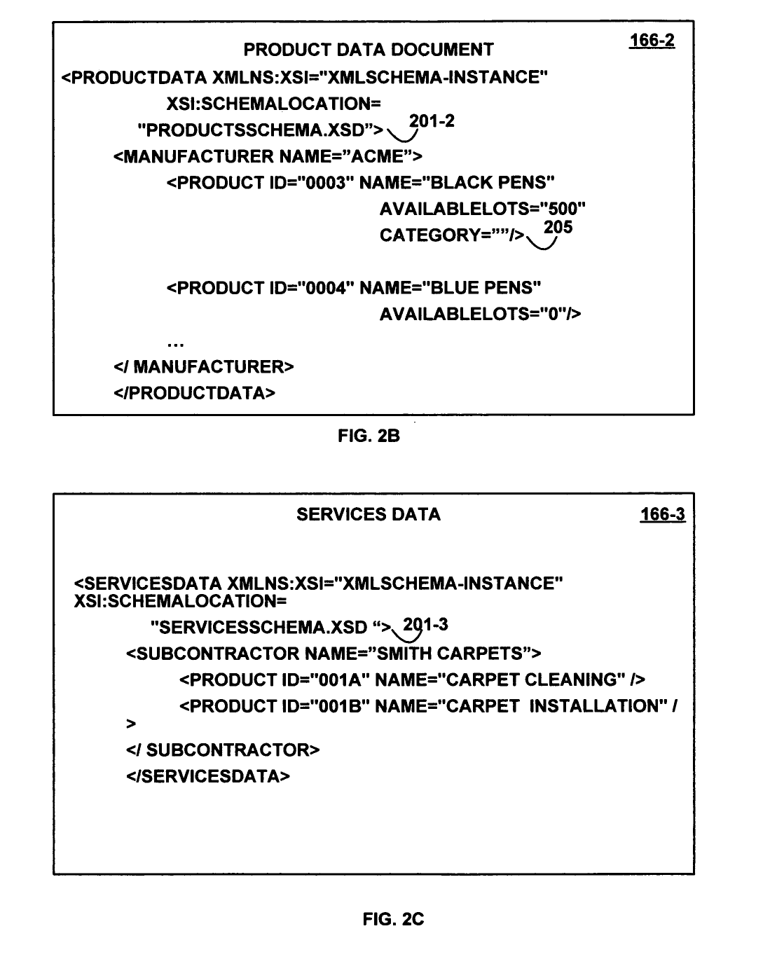

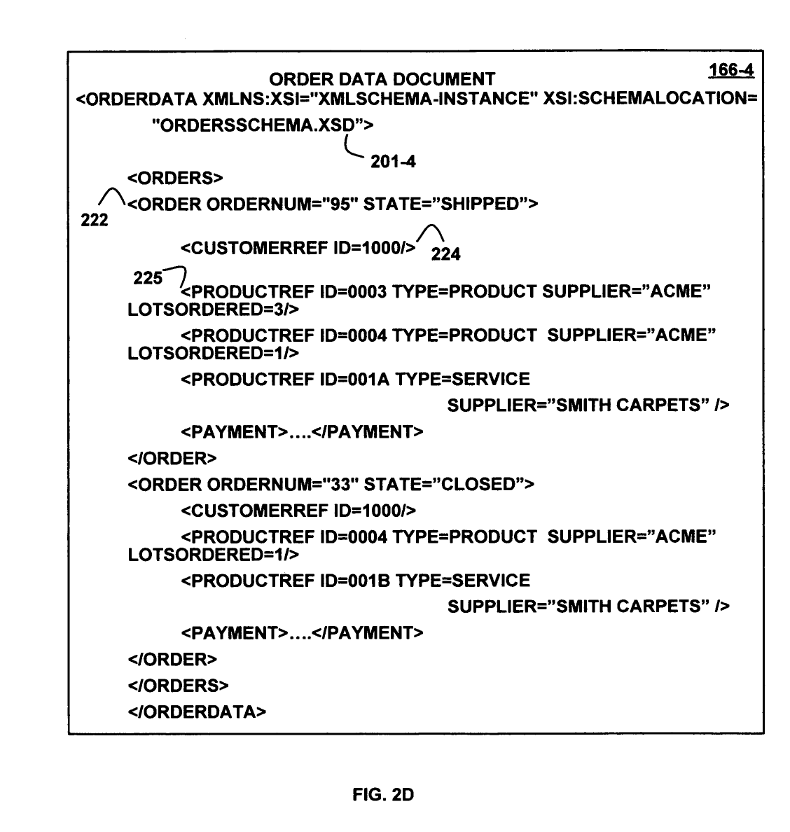

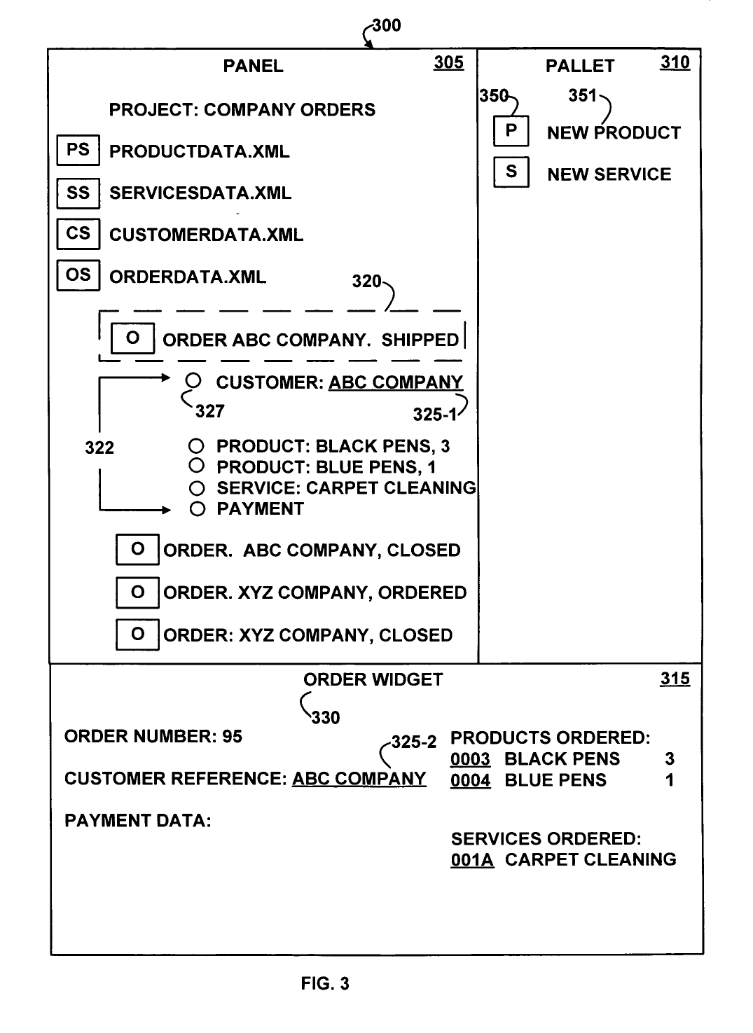

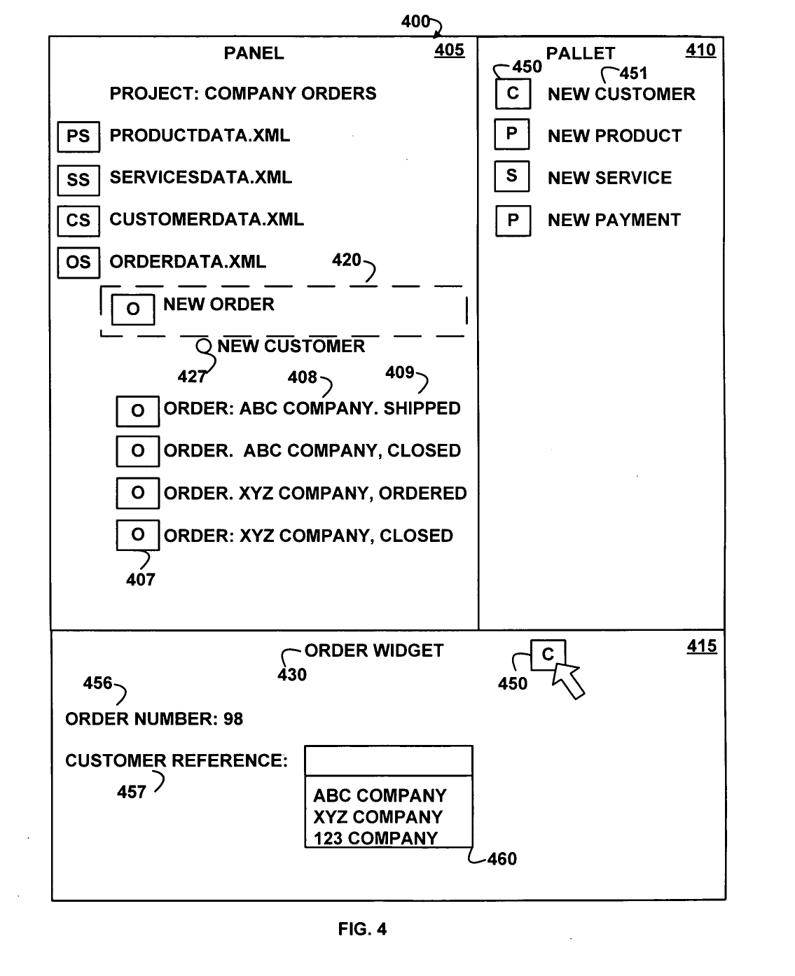

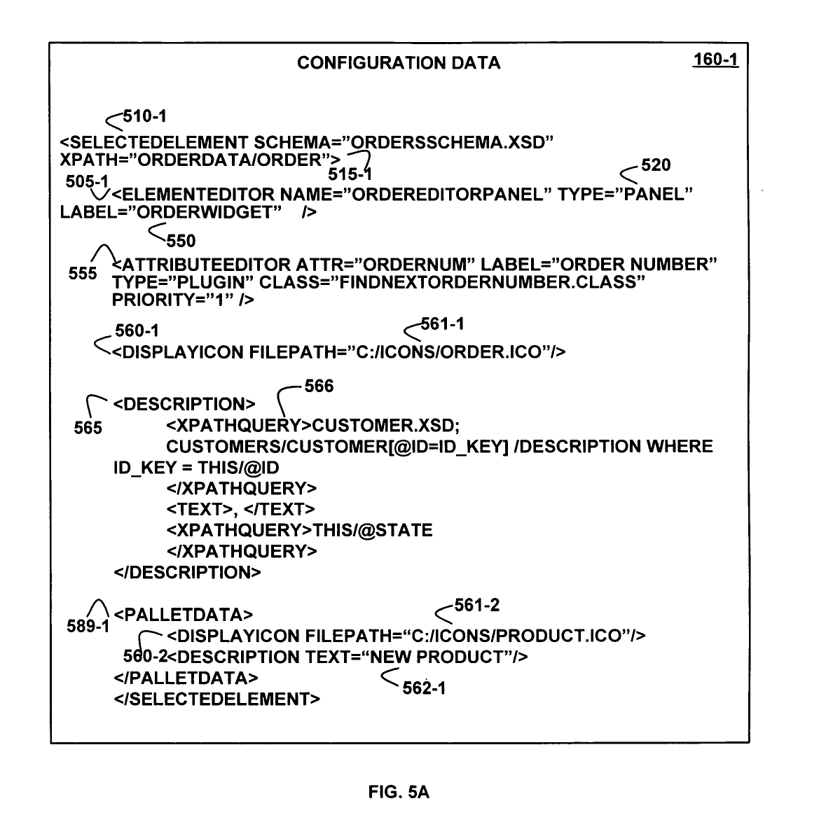

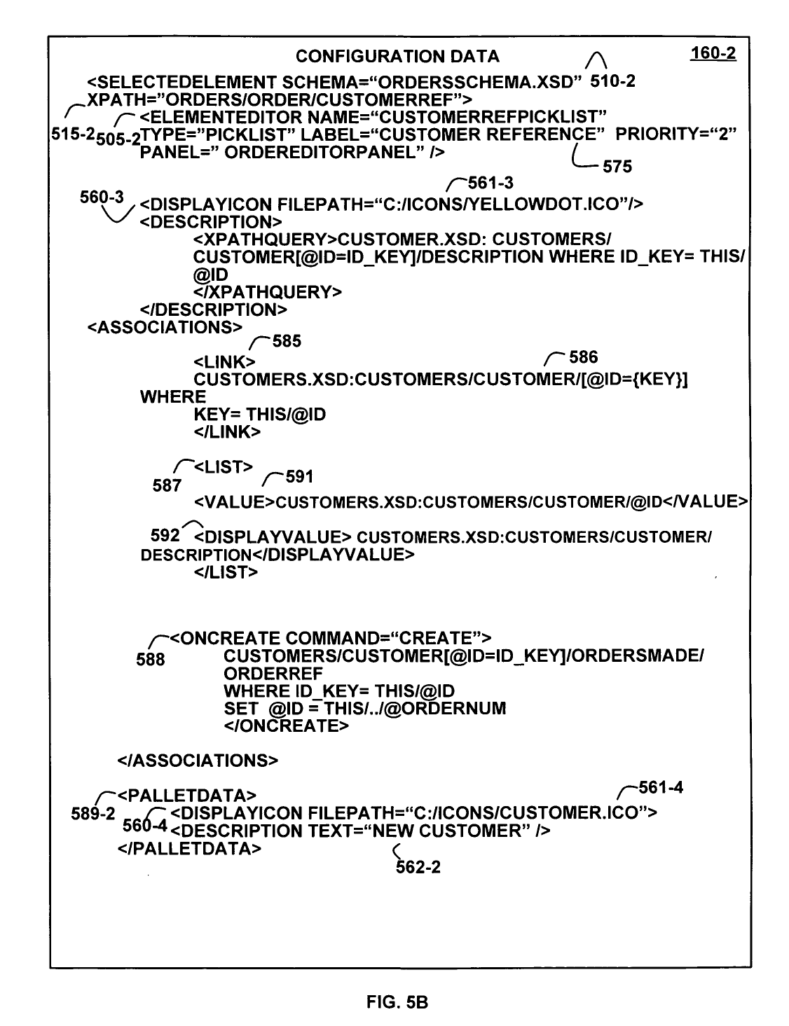

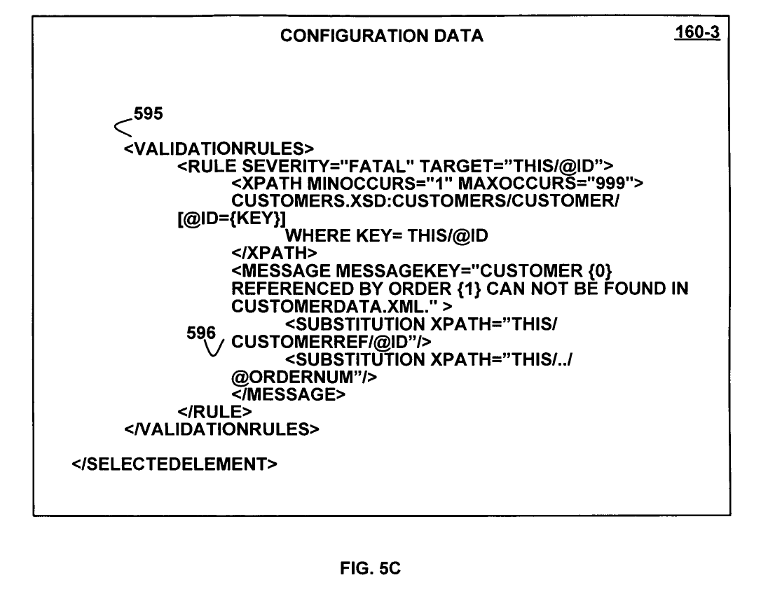

The editor 164 creates the configuration data 160 and displays and edits the documents 166 based on the schema 162 and the configuration data 160. In another embodiment, the editor 164 may also display and edit the documents 166 without the benefit of the configuration data 160. The documents 166 are further described below with reference to FIGS. 2A, 2B, 2C, and 2D. The user interface presented by the editor 164 to display the documents 166 is further described below with reference to FIGS. 3 and 4. The configuration data 160 is further described below with reference to FIGS. 5A, 5B, and 5C.

In an embodiment, the documents 166 are implemented via XML, but in other embodiments HTML (Hypertext Markup Language), GML (Generalized Markup Language), SGML (Standard Generalized Markup Language), XHTML (Extensible Hypertext Markup Language) or any other appropriate markup language may be used. A markup language intermixes the data that is to be displayed with markup instructions or control tags that specify or describe the format, structure, or manner in which the data is to be displayed.

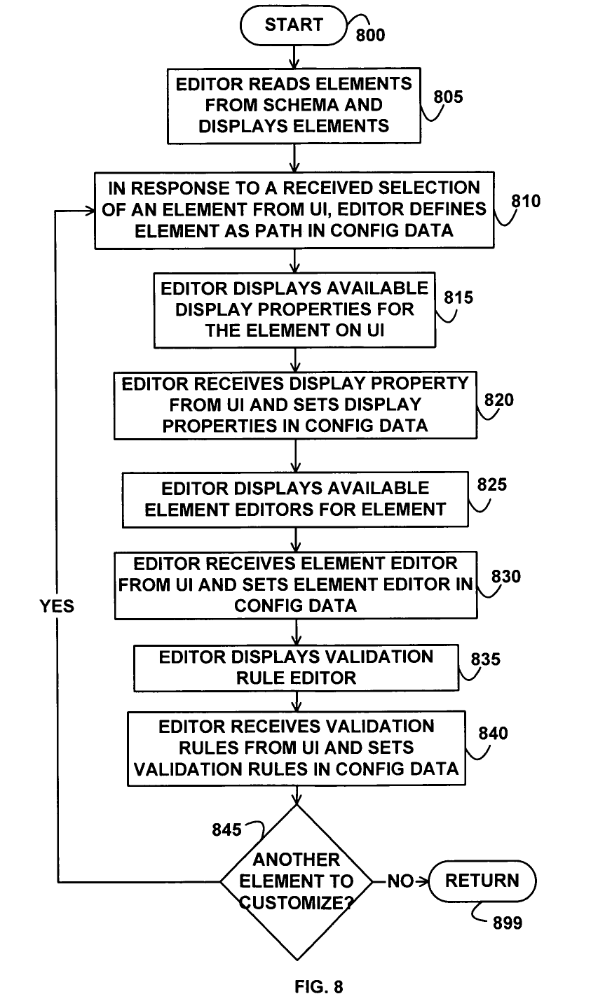

In an embodiment, the editor 164 includes instructions capable of executing on the processor 101 or statements capable of being interpreted by instructions executing on the processor 101 to perform the functions as further described below with reference to FIGS. 8, 9, 10, 11, and 12. In another embodiment, the editor 164 may be implemented in microcode. In another embodiment, the editor 164 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130.

Such tangible signal-bearing media, when carrying computer-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIGS. 2A, 2B, 2C, and 2D depict block diagrams of example respective documents 166-1, 166-2, 166-3, and 166-4, which are examples of the document 166 of FIG. 1. The example documents 166-1, 166-2, 166-3, and 166-4 use the schemas 162 to record the customer, product, and purchase data for a hypothetical company, but in other embodiments the documents 166 may be used for any purpose. The documents 166 include elements, which have content and optional attributes. An element is delimited by a start and an end tag. The content includes all text between the start and end tag of the element. Attributes are name-value pairs included in the start tag after the element name. In the example, attribute values are quoted, using single or double quotes, and each attribute name appears only once in any element. The content may include an entity, which is a named body of data that represents text, such as an unusual character.

FIG. 2A depicts a block diagram of an example customer data document 166-1, according to an embodiment of the invention. The customer data document 166-1 includes a schema attribute 201-1 a description element 202 and an orders made element 203, among others. The schema attribute 201 -1 identifies the schema 162 that defines the elements in the customer data document 166-1. The description element 202 describes the customer. The orders made element 203 references data in the order data document 166-4.

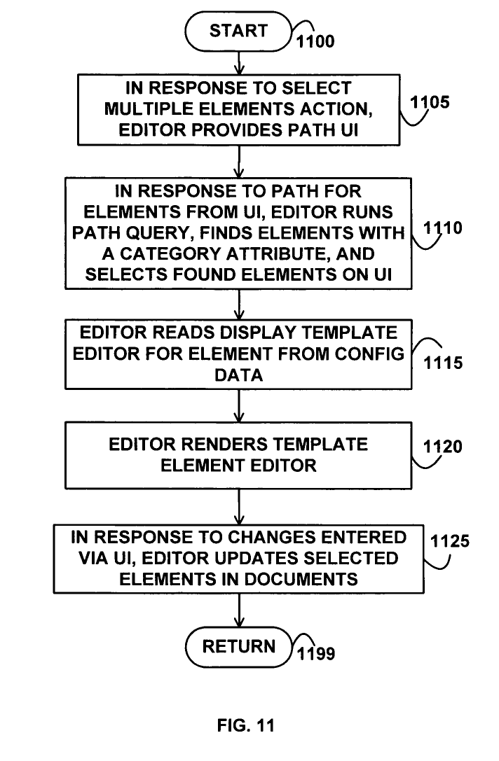

FIG. 2B depicts a block diagram of an example product data document 166-2, according to an embodiment of the invention. The product data document 166-2 * includes a schema attribute 201-2, which identifies the schema 162 that defines the elements in the product data document 166-2. The product data document 166-2 includes a category attribute 205. Using the category 205, the editor 164 selects and updates all product elements with the category attribute at once, as further described below with reference to FIG. 11.

FIG. 2C depicts a block diagram of an example services data document 166-3, according to an embodiment of the invention. The services data document 166-3 includes a schema attribute 201-3, which identifies the schema 162 that defines the elements in the product data document 166-3.

FIG. 2D depicts a block diagram of an example order data document 166-4, according to an embodiment of the invention. The order data document 166-4 includes a schema attribute 201-4, an order element 222, a customer reference element 224, and a product reference element 225, among others. The schema attribute 201-4 identifies the schema 162 that defines the elements in the order data document 166-4. The order element 222 is searched by queries, as further described below with reference to FIG. 8. The customer reference element 224 references data in the customer data document 166-1. The product reference element 225 references data in the product data document 166-2 or the services data document 166-3.

FIG. 3 depicts a block diagram of an example user interface 300 for selecting an existing order, which the editor 164 creates by interpreting the configuration data 160, the schema 162, and the documents 166, according to an embodiment of the invention. The user interface 300 may be displayed, e.g., on any or all of the terminals 121, 122, 123, or 124. The user interface 300 includes a panel 305, a pallet 310, and an order widget 315.

In response to selection of the element 320, which the user desires to edit, the editor 164 displays the elements 322, one of which is an icon 327, which is a display property of the customer reference 325-1. The editor 164 further displays the order widget 330 in response to selection of the element 320. The customer references 325-1 and 325-2 in the panel 305 and the order widget 330, respectively, are links from the order data document 166-4 to the customer data document 166-1. In response to selection of the links 325-1 or 325-2, the editor 164 opens an editor for the referenced customer.

The editor 164 further displays the icon 350 and the description 351 in the pallet 310. The icon 350 and the description text 351 are display properties. The editor 164 displays in the pallet 310 the elements that may be added to the order displayed in the order widget 330.

The order widget 315 includes customer reference data 325-2, which is implemented as a link. When the customer reference data 325-2 is selected, e.g., via a mouse, keyboard, or other input device, the editor 164 opens an editor for the reference customer. The editor 164 displays in the pallet 310 the elements that may be added to the currently-selected order widget 315.

FIG. 4 depicts a block diagram of an example user interface 400 for creating a new order, which the editor 164 creates by interpreting the configuration data 160, the schema 162, and the documents 166, according to an embodiment of the invention. The user interface 400 includes a panel 405, a pallet 410, and an order widget 415. In response to selection of the new order element 420, the editor 164 displays the order widget 430 for the order 456. In response to dragging the customer icon 450 from the pallet 410 to the order widget 415, the editor 164 displays the pick list 460 for the customer reference 457. The icons 407, 427, and 450 and the description text 408, 409, and 451 are display properties for their respective elements.

FIG. 5A depicts a block diagram of example configuration data 160-1, according to an embodiment of the invention. The configuration data 160-1 includes an element editor 505-1, a selected element 510-1, a path attribute 515-1, a panel 520, an order widget label 550, an attribute editor 555, display icon elements 560-1 and 560-2, display icon files 561-1 and 561-2, description text 562-1, a description element 565, a query element 566, and a pallet element 589-1.

The selected element 510-1 includes a path attribute 515-1 to an element or attribute in the schema 162. All of the data within the selected element 510-1 applies to the element or attribute in the path 515-1. The path attribute specifies a hierarchical route to a portion of a document 166 and is used to address the portion. In an embodiment, the path attribute may model the document 166 as a tree of nodes, but in other embodiments any appropriate technique may be used for addressing a portion of the document 166.

The query element 566 (“XpathQuery” in the example configuration data 160) allows the editor 164 to perform queries across multiple documents 166. The query element 566 defines a language to associate elements from different documents 166 using the following example query syntax: SchemaName: XPath WHERE (key definitions). Within the path element (“Xpath”), keys are defined in curly brackets, e.g., {KEY}. A key word ‘this’ refers to the ‘SelectedEntity’ XPath.

As the editor 164 creates the configuration data 160 for each element in the documents 166, the editor 164 defines the element editor 505-1 or attribute editor 555 for the element, which instructs the editor 164 how to display the element and attribute data. The editor 164 may load custom plug-in editor functions, such as integrating multiple entities, loading pick list data from an external source, and an validating the user against an external source. An example of loading pick list data from an external source is returning data from a database query. The example illustrated in FIG. 5A shows the attribute editor 555 for an order number. An example of validating the user is validating the user to determine if the user is allowed to edit the specified element.

The path 515-1 for the selected element 510-1 is the order element 515-1 in the schema 162 that is associated with the order data document 166-4 of FIG. 2D. Thus, when the editor 164 interprets a subsequent xpath query, the editor 164 searches the order element 222 in FIG. 2D.

The element editor 505-1 specifies a type of the user interface that the editor 164 uses to edit the selected element 510-1. The panel type 520 is provided by the editor 164. The editor 164 uses the label 550 as the titles 330 and 430 on the user interfaces 300 and 400, respectively.

The CLASS attribute is used by the editor 164 to identify an editor plugin for the attribute editor element 555. In an embodiment, the plug-in pre-fills the attribute's value and prevents the value from being edited. In response to the attribute editor element 555, the editor 164 displays the order number 456 (FIG. 4). In response to the priority of “1” for the attribute editor element 555, the editor 164 displays the order number 456 as the first field in the order widget 430 (FIG. 4).

In response to the display icon element 560-1 with the display icon file 561-1, the editor 164 displays the icon 407.

In response to the description element 565, the editor 164 appends values obtained by the query 566 with the text values in the order specified. For example, the query 566 causes the editor 164 to display the customer description 408 and order status 409.

In response to the pallet data element 589-1, the editor 164 displays the icon 350 identified by the icon file 561-2 and displays the description text 562-1 in the pallet 310 as the description 351.

FIG. 5B depicts a block diagram of example configuration data 160-2, according to an embodiment of the invention. The configuration data 160-2 includes an element editor 505-2, a selected element 510-2, a path attribute 515-2, a customer reference label 575, display icon elements 560-3 and 560-4, display icon files 561-3 and 561-4, description text 562-2, a link element 585, a query 586, a list element 587, an on create element 588, a pallet element 589-2, a value element 591, and a display value element 592.

The selected element 510-2 includes the path element 515-2 to an element or attribute in the schema 162. All of the data within the selected element 510-2 applies to the element or attribute in the path 515-2.

In response to the element editor 505-2, the editor 164 displays the customer reference label 575 as the customer reference 457 and pick list 460 in the order widget 415 of the user interface 400 (FIG. 4). The element editor 505-2 is the type of the user interface feature used to edit the selected element 510-2. In an embodiment, the pick list type is provided by the editor 164. The editor 164 displays the label 575 as the label 457 in the user interface 400 (FIG. 4). The customer reference label 575 is the text used by the editor 164 to describe the element on the user interface 400.

In response to the priority of “2” for the element editor 505-2, the editor 164 displays the customer reference 457 as the second field in the order widget 415.

In response to the link element 585, the editor 164 creates a link from the selected element 510-2 to the element found by the query 586. The link may reference an element in a different document from the document 160-2. For example, in response to the link element 585, the editor 164 creates the links 325-1 and 325-2 from the selected element 510-2 (associated with the element 222 in the document 166-4 of FIG. 2D) to the element 202 in the document 166-1.

In response to the list element 587, the editor 164 creates a list of available values for the selected element 510-2. The list element 587 includes the value element 591 and the display value element 592. The value element 591 contains the value that the editor 164 assigns to the selected element 510-2 if chosen. The display value 592 is the text for the value 591 that the editor 164 displays in the pick list box 460 (FIG. 4). Thus, when a display value 592 is chosen from the pick list box 460 in the user interface 400 of FIG. 4, the editor 164 assigns the value 591 to the selected element 510-2. The editor 164 may find the values and the display values for the selected element 510-2 in a different document than the document 160-2.

In response to the on create element 588, the editor 164 executes the command when the selected element 510-2 is acted upon via the user interface 300 or 400. For example, in response to the user selecting the new order 420 via the user interface 400, the editor 164 creates the OrderRef element in the orders made element 203 in the customer data 166-1 and sets the OrderRef id to the current order's orderNum value. The editor 164 then displays the order number 456 on the user interface 400 of FIG. 4.

In response to the pallet data element 589-2, the editor 164 displays the icon 450 identified by the icon file 561-4 and displays the description text 562-2 in the pallet 410 as the description 451.

FIG. 5C depicts a block diagram of example configuration data 160-3, which includes validation rules, according to an embodiment of the invention. In response to the validation rule element 595, the editor 164 determines whether the target of the customer reference identifier 596 does not have an existing customer element. If the target of customer reference identifier 596 does not have an existing customer element, then the editor 164 returns a fatal error message. In an embodiment, the editor 164 executes the validation rule 595 when the document 166 is saved, in order to verify that OrderData document 166 contains valid references to data in the CustomerData document.

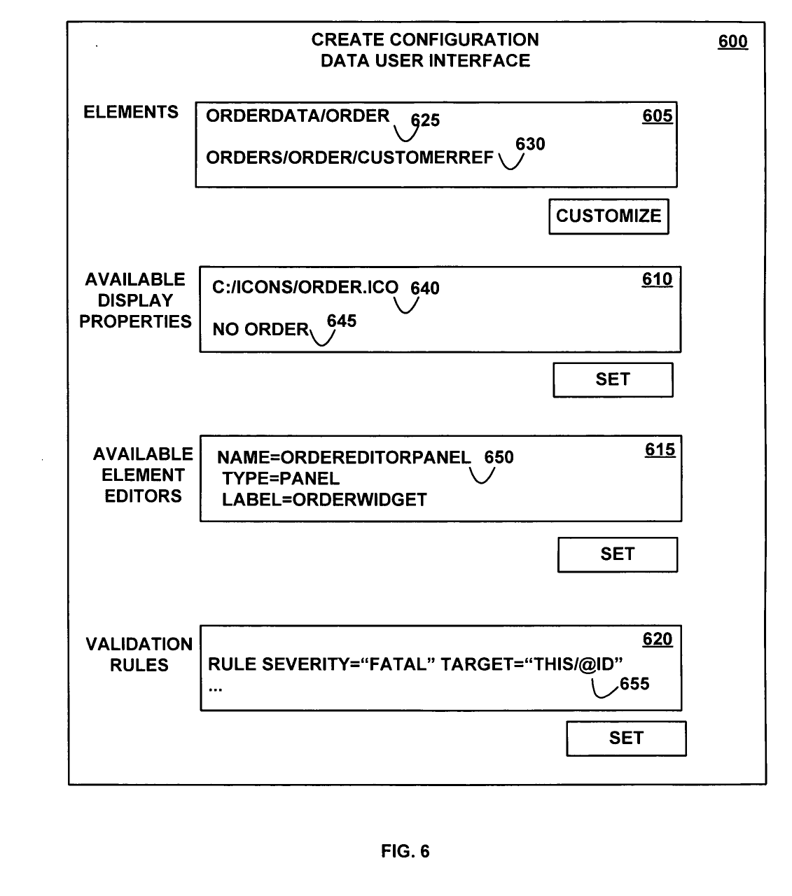

FIG. 6 depicts a block diagram of a user interface 600 for creating the configuration data 160, according to an embodiment of the invention. The editor 164 displays the user interface 600 on the terminals 121, 122, 123, or 124. In an embodiment, the editor 164 displays the user interface 600 via a schema 162, a document 166, and configuration data 160. The user interface 600 includes an elements user interface 605, an available display properties user interface 610, an available element editors user interface 615, and a validation rules user interface 615. The editor 164 processes the user interface 600, as further described below with reference to FIG. 8.

The elements user interface 605 includes example elements 625 and 630, which the editor 164 reads from the schema 162 and displays. The user may select one or more of the elements 625 and 630 for customization.

The available display properties user interface 610 includes example display properties 640 and 645, which the editor 164 displays for the selected element that the user requested customization for via the user interface 605. The example display property 640 is a display icon, and the example display property 645 is description text.

The available element editors user interface 615 includes an element editor 650, which the editor 164 displays. Other example available element editors may include widgets, pick lists, choice boxes, panels, menus, sliders, buttons, or any other appropriate user interface construct.

The validation rules user interface 620 includes an example validation rule 655, which the editor 164 displays.

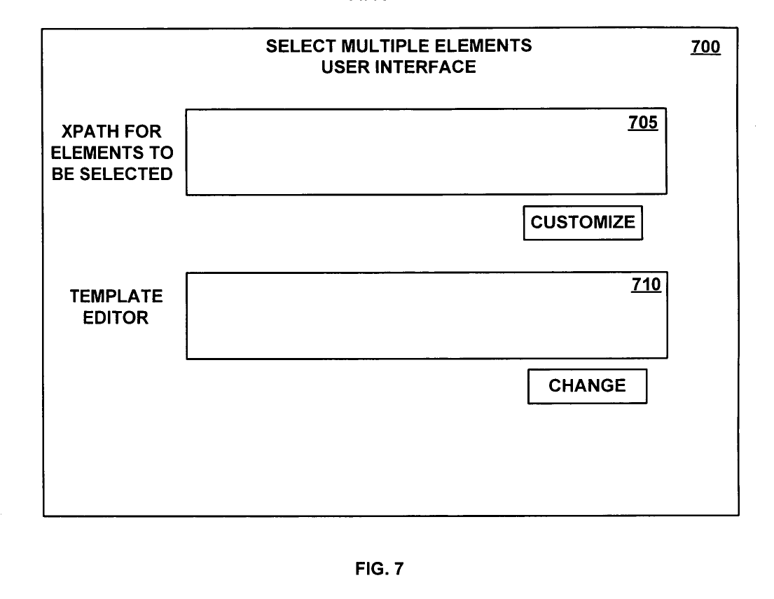

FIG. 7 depicts a block diagram of a user interface 700 for editing multiple elements, according to an embodiment of the invention. The editor 164 displays the user interface 700 on the terminals 121, 122, 123, or 124. In an embodiment, the editor 164 displays the user interface 700 via a schema 162, a document 166, and configuration data 160. The user interface 700 includes an xpath for elements to be selected interface 705 and a template editor interface 710.

FIG. 8 depicts a flowchart of example processing for creating the configuration data 160, according to an embodiment of the invention. Control begins at block 800. Control then continues to block 805 where the editor 164 reads elements from the schema 162 that is associated with a document 166 and displays the elements on the user interface 605. For example, the editor 164 reads and displays the elements 625 and 630, instances of which are illustrated as elements 222 and 224, respectively, in FIG. 2D. Control then continues to block 810 where the editor 164 receives a selection of one or more of the elements 625 or 630 from the user interface of a displayed element 605 and a request to customize the element(s), and in response to the selection, the editor 164 defines the element as a path in the configuration data 160, e.g., the editor 164 receives the element 625 “orderdata/order” from the user interface 600 and defines the element 625 as the path 515-1 in FIG. 5A.

Control then continues to block 815 where the editor 164 displays available display properties for the selected element on the user interface 610. Examples of display properties include display icons, such as the display icon 640 and description text, such as the description text 645. Control then continues to block 820 where the editor 164 receives a display property from the user interface 610 and sets the received display property in the configuration data 160. For example, the editor 164 receives the display icon 640 and sets the display icon 640 into the display icon elements 560-1 as the display icon 561-1 in the configuration data 160-1 of FIG. 5A. As other examples, the editor 164 may receive and set the display icons 561-2, 561-3 or 561-4 or the description text 562-1 or 562-2.

Control then continues to block 825 where the editor 164 displays available element editors for the selected element in the user interface 615, such as the element 25 editor 650. Available element editors may include widgets, pick lists, choice boxes, panels, menus, sliders, buttons, or any other appropriate user interface construct.

Control then continues to block 830 where the editor 164 receives an element editor from the user interface 615 and sets the received element editor in the configuration data 160. For example, the editor 164 may receive the element editor 650 and set the received element editor 650 into the element editor 505-1 in the configuration data 160-1.

Control then continues to block 835 where the editor 164 displays the available rules for the selected element in the validation rule editor user interface 620. Control then continues to block 840 where the editor 164 receives the selected validation rules from the validation rule user interface 620, e.g., the validation rules 655 and sets the received validation rules 655 in the configuration data 160-3 as the validation rules 595.

Control then continues to block 845 where the editor 164 determines whether another element is selected via the user interface 600 to customize. If the determination at block 845 is true, then control returns to block 810, as previously described above.

If the determination at block 845 is false, then another element to customize is not selected, so control continues to block 899 where the logic of FIG. 8 returns.

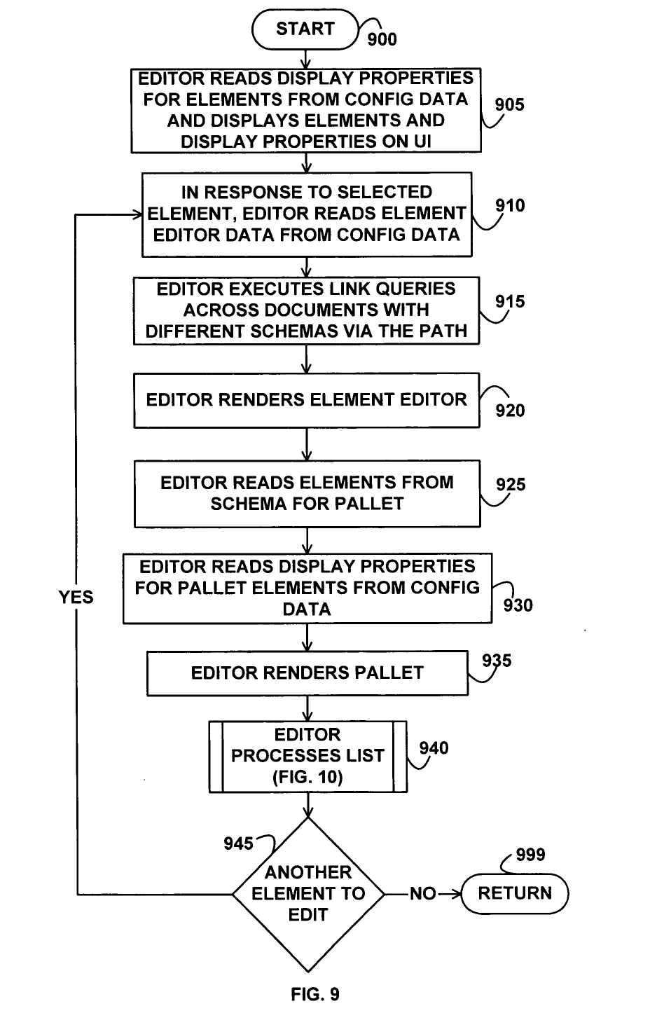

FIG. 9 depicts a flowchart of example processing for displaying elements, according to an embodiment of the invention. Control begins at block 900. Control then continues to block 905 where the editor 164 reads elements from the documents 166, finds display properties (e.g., display icons or description text) associated with the elements in the configuration data 160 and renders the elements on the user interface 300 or 400 based on their associated display properties. That is, the editor 164 uses the display properties to determine how to display the elements. For example, the editor 164 reads the display icons 561-1, 561-2, 561-3, and 561-4 associated with the elements 560-1, 560-2, 560-3, and 560-4 and displays the respective icons 407, 350, 327 and 427, and 450. As another example, the editor 164 reads the description text 562-1 or 562-2 associated with the elements 560-2 and displays the description text 351 and 451.

Control then continues to block 910 where, in response to a selected element that the user desires to edit, the editor 164 reads the element editor data from the configuration data 160. For example, in response to a selection of the elements 320 or 420 in the user interfaces 300 or 400, the editor 164 reads the element editor data 505-1 or 505-2, respectively.

Control then continues to block 915 where the editor 164 executes the link queries against a different document 166, which may have a different schema 162. For example, the editor 164 executes the query 586 in the link element 585 (FIG. 5B) and creates a link from the element 510-2 to the element found by the query 586 in the path 515-5. The link may reference an element specified by the path 515-5 in a different document from the document 160-2 having a different schema. For example, in response to the link element 585, the editor 164 creates the links 325-1 and 325-2 from the selected element 510-2 (associated with the element 222 in the document 166-4) to the element 202 in the document 166-1.

Control then continues to block 920 where the editor 164 renders the element editor and displays the element editor on the user interface. For example, the editor 164 renders the element editor data 505-1 by displaying the order widget 315 on the user interface 300 and renders the element editor 505-2 by displaying the pick list 460 on the user interface 400.

Control then continues to block 925 where the editor 164 reads the elements from the schema 162 for the pallet 589-1 or 589-2.

Control then continues to block 930 where the editor 164 reads the display properties for the data for the pallet elements from the configuration data 160. For example, the editor 164 reads the display properties 561-2 and 562-1 from the configuration data 160-1 or reads the display properties 562-2 and 561-4 from the configuration data 160-2.

Control then continues to block 935 where the editor 164 renders the pallet and displays the display properties. For example, the editor 164 displays the icon 350 identified by the icon file 561-2 and displays the description text 562-1 in the pallet 310 as the description 351. As another example, the editor displays the icon 450 identified by the icon file 561-4 and displays the description text 562-2 in the pallet 410 as the description 451.

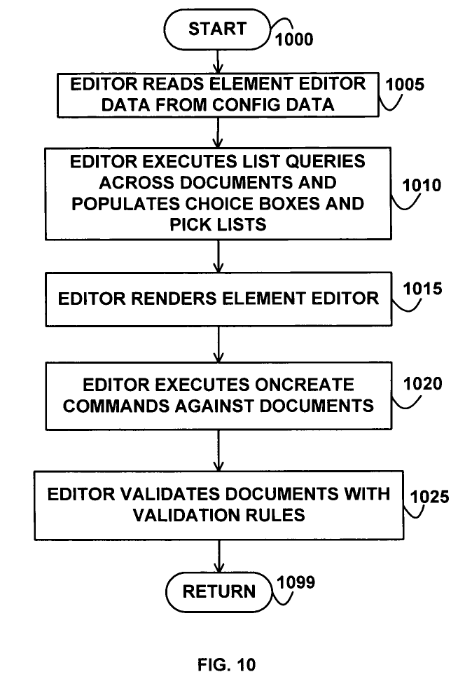

Control then continues to block 940 where, in response to a request to create a new element, e.g. by dragging the new customer icon 450 from the pallet 410 to the order widget panel 415 (FIG. 4), the editor 164 processes the list elements, as further described below with reference to FIG. 10.

Control then continues to block 945 where the editor 164 determines whether another element is selected to edit on the user interface 300 or 400. If the determination at block 945 is true, then control returns to block 910, as previously described above.

If the determination at block 945 is false, then another element to edit is not selected, so control continues to block 999 where the logic of FIG. 9 returns.

FIG. 10 depicts a flowchart of further example processing for displaying elements, according to an embodiment of the invention. Control begins at block 1000.

Control then continues to block 1005 where the editor 164 reads the element editor data 505-2 associated with the new element from the configuration data 160. For example, the editor 164 reads the element editor data 505-2 from the configuration data 160-2 that is associated with the customer reference element that the user requested to create, as previously described above with reference to block 940.

Control then continues to block 1010 where the editor 164 executes queries across the documents and populates choice boxes and pick lists with values returned by the queries. For example, the editor 164 executes the query 587 against the document 166-1 and populates the pick list 460 with the results. Control then continues to block 1015 where the editor 164 renders the element editor 505-2 on the user interface 400 and displays the pick list 460 with the results of the query.

Control then continues to block 1020 where the editor 164 executes on create commands against the documents 166. In response to the on create element 588, the editor 164 creates the OrderRef element in the orders made element 203 in the customer data 166-1 and sets the OrderRef id to the current order's orderNum value. The editor 164 then displays the order number 456 on the user interface 400. The on create element 588 is used to define actions to be taken by the editor in response to the creation of document content within the editor.

Control then continues to block 1025 where the editor 164 validates the documents 166 with the validation rules 595. For example, in response to the validation rule element 595, the editor 164 determines whether the target of the customer reference identifier 596 does not have an existing customer element in the customer data document 166-1. If the target of customer reference identifier 596 does not have an existing customer element, then the editor 164 returns a fatal error message. In an embodiment, the editor 164 executes the validation rule 595 when the document 166 is saved, in order to verify that OrderData document 166 contains valid references to data in the CustomerData document.

Control then continues to block 1099 where the logic of FIG. 10 returns.

FIG. 11 depicts a flowchart of example processing for editing multiple elements, according to an embodiment of the invention. Control begins at block 1100. Control then continues to block 1105 where, in response to a select multiple elements action, the editor 164 displays the path user interface 705 on the user interface 700. Control then continues to block 1110 where, in response to a path for elements from the user interface, the editor 164 executes the path query, finds all elements in the path that contain the category attribute 205, and selects the found elements on the user interface.

Control then continues to block 1115 where the editor 164 reads the display template editor for the element from the configuration data 160. Control then continues to block 1120 where the editor 164 renders the template element editor and displays the template element editor 710 on the user interface 700. Control then continues to block 1125 where, in response to changes entered via the user interface 710, the editor 164 updates the found selected elements in the documents 166 with the entered changes. Control then continues to block 1199 where the logic of FIG. 11 returns.

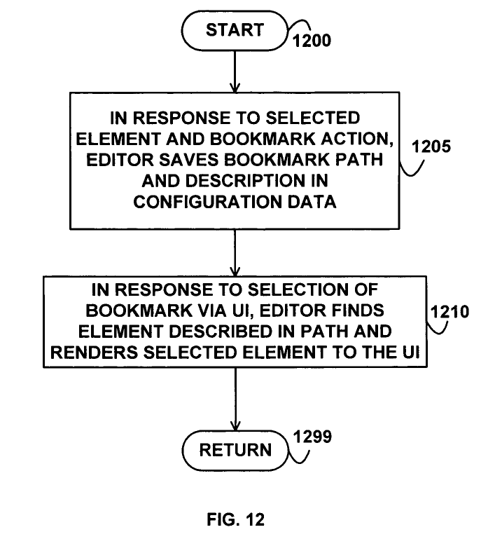

FIG. 12 depicts a flowchart of example processing for creating element bookmarks, according to an embodiment of the invention. Control begins at block 1200. Control then continues to block 1205 where, in response to a selected element and a bookmark action, the editor 164 saves a bookmark path and description of the selected element in the configuration data 160. Control then continues to block 1210 where, in response to selection of the bookmark via the user interface, the editor 164 finds the element described in the path and displays the selected element on the user interface. Control then continues to block 1205 where the logic of FIG. 12 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
reading a plurality of elements from a schema, wherein the schema is associated with a document;
in response to selection of a selected element of the plurality of elements, defining the selected element as a path in configuration data that is associated with the document, setting a selected display property for the selected element in the configuration data, and setting a selected element editor for the selected element in the configuration data; and
displaying the document via the configuration data.

2. The method of claim 1, wherein the displaying the document further comprises:
executing a query specified in the configuration data to a portion of a different document having a different associated schema, wherein the path specifies the portion; and
displaying a result of the query.

3. The method of claim 1, wherein the displaying the document via the configuration data further comprises:
displaying the display property.

4. The method of claim 1, further comprising:
setting a validation rule in the configuration data.

5. The method of claim 4, further comprising:
validating the document with the validation rule.

6. The method of claim 1, further comprising:
displaying a plurality of available display properties for the selected element.

7. The method of claim 1, further comprising:
displaying a plurality of available element editors for the selected element.

8. The method of claim 1, wherein the display property comprises a display icon.

9. The method of claim 1, wherein the display property comprises description text.

10. A signal-bearing medium encoded with instructions, wherein the instructions when executed comprise:
reading a plurality of elements from a schema, wherein the schema is associated with a document;
in response to selection of a selected element of the plurality of elements, defining the selected element as a path in configuration data that is associated with the document, setting a selected display property for the selected element in the configuration data, and setting a selected element editor for the selected element in the configuration data, wherein the selected element editor specifies a user interface for the selected element; and
displaying the document via the configuration data, wherein the displaying the document further comprises executing a query specified in the configuration data to a portion of a different document having a different associated schema, wherein the path specifies the portion, and displaying a result of the query.

11. The signal-bearing medium of claim 10, wherein the displaying the document via the configuration data further comprises:
displaying the display property.

12. The signal-bearing medium of claim 10, further comprising:
setting a validation rule in the configuration data.

13. The signal-bearing medium of claim 12, further comprising:
validating the document with the validation rule.

14. The signal-bearing medium of claim 10, further comprising:
displaying a plurality of available display properties for the selected element; and
displaying a plurality of available element editors for the selected element.

15. The signal-bearing medium of claim 10, further comprising:
finding elements in the path that have a category element; and
updating all of the elements in the path that have a category element with a change.

16. A method for configuring a computer, comprising:
configuring the computer to read a plurality of elements from a schema, wherein the schema is associated with a document;
configuring the computer to, in response to selection of a selected element of the plurality of elements, defining the selected element as a path in configuration data that is associated with the document, setting a selected display property for the selected element in the configuration data, and setting a selected element editor for the selected element in the configuration data, wherein the selected element editor specifies a user interface for the selected element; and
configuring the computer to display the document via the configuration data, wherein the displaying the document further comprises executing a query specified in the configuration data to a portion of a different document having a different associated schema, wherein the path specifies the portion, and displaying a result of the query.

17. The method of claim 16, wherein the configuring the computer to display the document via the configuration data further comprises:
configuring the computer to display the display property.

18. The method of claim 16, further comprising:
configuring the computer to display a plurality of available display properties for the selected element; and
configuring the computer to display a plurality of available element editors for the selected element.

19. The method of claim 16, further comprising:
configuring the computer to find elements in the path that have a category element; and
configuring the computer to update all of the elements in the path that have a category element with a change.

20. The method of claim 16, further comprising:
configuring the computer to save a bookmark path and description of an associated element in the configuration data;
configuring the computer to find the associated element via the bookmark path; and
configuring the computer to display the associated element.
